(19) United States
(12) Patent Application Publication
(10) Pub. No.: US 2008/0052035 A1
(43) Pub. Date: Feb. 28, 2008

(54) Three-Dimensional Measurement Method and Device

(76) Inventors: Fabrice Moreau, Saint Michel Sur Rhone (FR); Joel Moreau, Chemin de la Croix Blanche (FR)

Correspondence Address: CANTOR COLBURN, LLP, 20 Church Street, 22nd Floor, Hartford, CT, 06103, US

(21) Appl. No.: 11/628,923

(22) PCT Filed: Jun. 7, 2005
(86) PCT No.: PCT/FR05/01394

§ 371 Date: Sep. 26, 2007

(30) Foreign Application Priority Data
Jun. 8, 2004 (FR) 0406174

(51) Int. Cl. G06F 15/00

(52) U.S. Cl. 702/152

(57) ABSTRACT

The invention relates to a method for the three-dimensional measurement of the co-ordinates of significant points of a part. The inventive method comprises the following steps consisting in: producing a physical measurement standard (2) that is representative of the part to be measured; taking a measurement, in a meteorology laboratory, of the co-ordinates, X<SB>E</SB>Y<SB>E</SB>Z<SB>E</SB>, of significant points in a referential system that is linked to the measurement standard (2); taking a measurement, in an industrial environment, of the co-ordinates of significant points with a measuring device that can provide the three co-ordinates, X<SB>E′</SB>Y<SB>E′</SB>Z<SB>E′</SB>, of each significant point in a referential system that is linked to the measurement standard (2); determining the deviation ? for each significant point between the co-ordinates measured in meteorology laboratory conditions, X<SB>E</SB>Y<SB>E</SB> Z<SB>E</SB>, and the co-ordinates measured in industrial operation conditions, X<SB>E′</SB>Y<SB>E′</SB>Z<SB>E′</SB>; storing the deviation (?) for each significant point in a memory; taking a measurement, in industrial operation conditions, of co-ordinates X<SB>P</SB>Y<SB>P</SB>Z<SB>P</SB> of each significant point of a part (10) with the aforementioned measuring device; storing co-ordinates X<SB>P</SB>Y<SB>P</SB>Z</SB>P</SB> in a memory; using a correction calculator for the digital processing of each co-ordinate X<SB>P</SB>Y<SB>P</SB>Z<SB>P</SB> comprising the algebraic deduction of deviation ?, such as to obtain corrected co-ordinates X<SB>PC</SB>Y<SB>PC</SB>Z<SB>PC′</SB>; and digitally processing the corrected co-ordinates, X<SB>PC</SB>Y<SB>PC</SB>Z<SB>PC</SB>, in order to determine a dimensional defect in the part (10).

The present invention relates to a method of three-dimensional measurement and a device for implementing this method.

The design of a part comprises, firstly, a phase of producing a drawing exhibiting dimensions and tolerances. The defining drawing thus defines surfaces which delimit the volume of the part to be made in the course of an industrial operation of molding, die stamping, removal of material, etc. Each surface is defined by its shape and its position in a reference frame tied to the part.

The role of inspection is to evaluate the agreement between the drawing and the part actually made, that is to say a three-dimensional solid.

For this purpose, essentially two types of inspection of mechanical parts are known.

On the one hand, so-called multidimensional inspection is known. Multidimensional inspection uses an installation dedicated to the inspection of a part. This installation is equipped with measurement means (inductive, pneumatic, optical, capacitive sensor) which each make a measurement of a dimension with respect to a gauge. In practice, a multidimensional inspection installation uses a series of sensors positioned in a specific manner as a function of the geometry of the part in question. These sensors measure a deviation with respect to the nominal dimension, the latter being demarcated by the surface of the gauge. Customarily, the sensors are gauged according to a predetermined periodicity.

Multidimensional inspection is particularly suited to the inspection of parts alongside a mass production line.

Specifically, this type of inspection exhibits the following advantages:
implementation by relatively unskilled staff, since it suffices to position the part on the installation,
speed of inspection, since the various sensors each make their measurement simultaneously,
high precision even in an industrial environment which involves substantial variations of temperature, vibrations, etc.; this precision is obtained by the fact that the measurement, which is made, is a relative measurement with respect to a gauge.

This type of inspection is, however, not without drawback.

Foremost among the drawbacks may be cited the substantial cost of devising and making an installation, as well as relatively lengthy delivery times.

A multidimensional inspection installation is, moreover, specifically suited to the geometry of a part. A modification of this part entails a redefinition of the multidimensional installation which is assigned to the inspection of the part in question.

The other type of mechanical part inspection uses a coordinate measuring machine (CMM). These machines exhibit a structure comprising three pairwise orthogonal guide rules. These guide rules make it possible to reach, in a unique manner, all points of a parallelepipedal volume defined by the guide rules.

These machines are supplemented with a prober and a computer.

The prober makes a measurement of the coordinates of the surface of a part to be measured by contact with the surface of the part. The coordinates are read off in the reference frame of the machine.

These coordinates may thereafter be processed digitally to determine the dimensional quality of the part as a function of the criteria such as dimension, flatness, circularity, concentricity, etc.

Measurement with the aid of a coordinate measuring machine has, as advantage, the fact that one and the same machine can measure parts of any geometry at the cost of a simple reprogramming between the measurement of two parts.

These machines have in particular as advantages:
of being rapidly available, since they are mass produced by manufacturers,
of being programmable and hence enabling measurements to be made of parts of all geometries.

However, the coordinate measuring machines are sensitive to the environment in which they work (variation of temperature, vibration, etc.).

Thus, they lose their precision when they are installed in an industrial environment such as a workshop. Moreover, they are fragile and must be handled by specialist staff.

Finally, their inspection time is relatively long. The inspection may last several minutes compared with the few seconds necessary for an inspection with a multidimensional measurement system.

An aim of the invention is to provide a method of three-dimensional measurement which can be installed in an industrial environment, for example, on a production line, while guaranteeing the accuracy of the coordinates of the points before their digital processing and the swiftness of the inspections.

The subject of the invention is essentially a method of three-dimensional measurement of coordinates of significant points of a part, comprising the steps consisting in:
making a physical gauge representative of the part to be measured,
making a measurement in a meteorology laboratory of the coordinates X_{E} Y_{E} Z_{E} of significant points in a reference frame tied to the gauge,
making, in an industrial environment, a measurement of the coordinates of the significant points with a measurement rig that can give the three coordinates X_{E ′} Y_{E′} Z_{E′} of each significant point in a reference frame tied to the gauge,
determining the deviation Δ for each significant point between the coordinates measured X_{E} Y_{E} Z_{E} under meteorology laboratory conditions and the coordinates measured X_{E′} Y_{E′} Z_{E′} under the industrial conditions of use,
storing in a memory the deviation Δ
making, on the part to be measured, in an industrial environment a measurement of the coordinates X_{P} Y_{P} Z_{P} of each significant point with the measurement rig,
storing in a memory the coordinates X_{P} Y_{P} Z_{P},
performing a digital processing by a computer for correcting each coordinate X_{P} Y_{P} Z_{P} by algebraic deduction of the deviation Δ
performing a digital processing of the corrected coordinates X_{PC} Y_{PC} Z_{PC} so as to determine a dimensional defect of the part.

The basis of the invention is to measure coordinates with respect to a physical gauge. The method according to the invention may therefore be put in place in an industrial environment since the measurements are made with respect to a physical gauge and nevertheless make it possible to gather coordinates which may form the subject of a digital processing to determine the conformity of the part.

The corrected coordinates may thereafter be processed by a mathematical procedure applied to the three-dimensional measurement.

According to a preferred possibility, the corrected coordinates X_{PC} Y_{PC} Z_{PC} are processed by the least squares procedure.

In an embodiment the method consists in:

fixing a unidirectional rig for measurement with respect to the part reference frame, two of the coordinates of the measurement rig being fixed in the reference frame tied to the part,
performing a measurement of a point of the part, two of the coordinates being the coordinates of the means of measurement in the reference frame, the third coordinate being the value sought.

The invention also relates to a device allowing the implementation of the method of three-dimensional measurement of coordinates of significant points of a part comprising:
a physical gauge representative of the part to be measured,
a rig for measuring the part to be measured that can be gauged by comparative measurement on the gauge,
a calculation unit connected to the measurement rig exhibiting storage means in which may be stored
the coordinates X_{E} Y_{E} Z_{E},
the coordinates X_{E′} Y_{E′} Z_{E′},
the deviation Δ for each significant point,
the coordinates X_{P} Y_{P} Z_{P}
   and means of calculating the corrected coordinates X_{PC} Y_{PC} Z_{PC} by algebraic deduction of the deviation Δ of the X_{P} Y_{P} Z_{P} and of processing of the corrected coordinates X_{PC} Y_{PC} Z_{PC} by a procedure applied to the three-dimensional measurement.

According to different variants, the method implements a measurement rig operating by probing, by optical, pneumatic or capacitive measurement.

In a form of embodiment, the measurement rig is a three-dimensional measurement rig capable of determining three coordinates of a point of the part in a reference frame tied to the part.

The measurement rig may then be a coordinate measuring machine.

In the case of a part to be measured exhibiting a complex geometry, the measurement rig comprises unidirectional elements of the measurements and three-dimensional elements of measurements.

For the proper comprehension thereof, the invention is described with reference to the appended drawing representing by way of nonlimiting example.

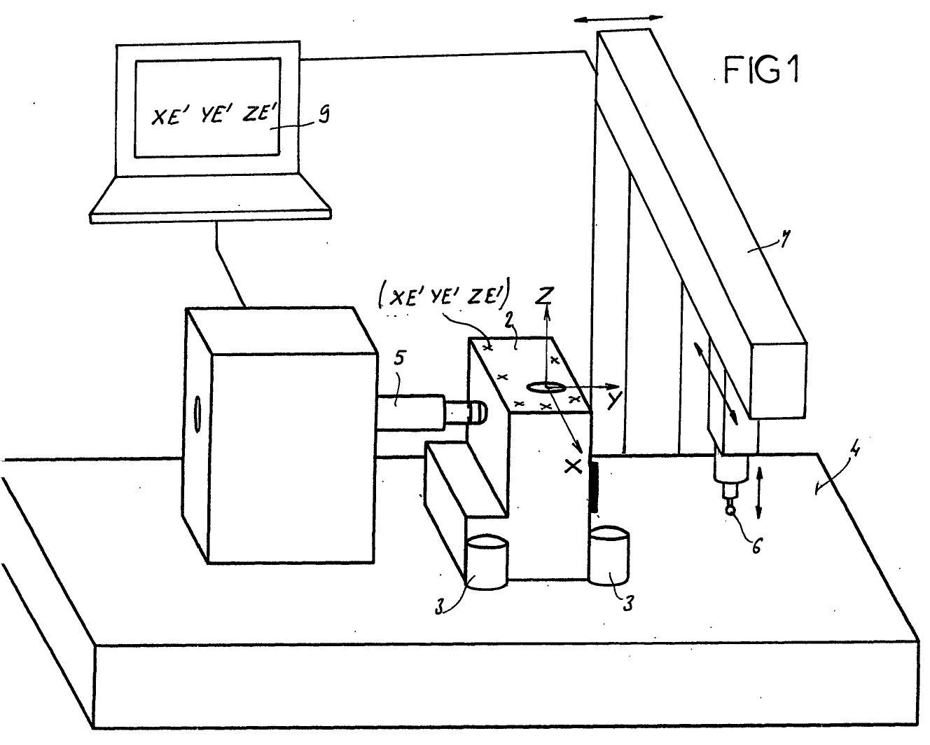

FIG. 1 represents a measurement of a gauge on a measurement rig under industrial conditions,

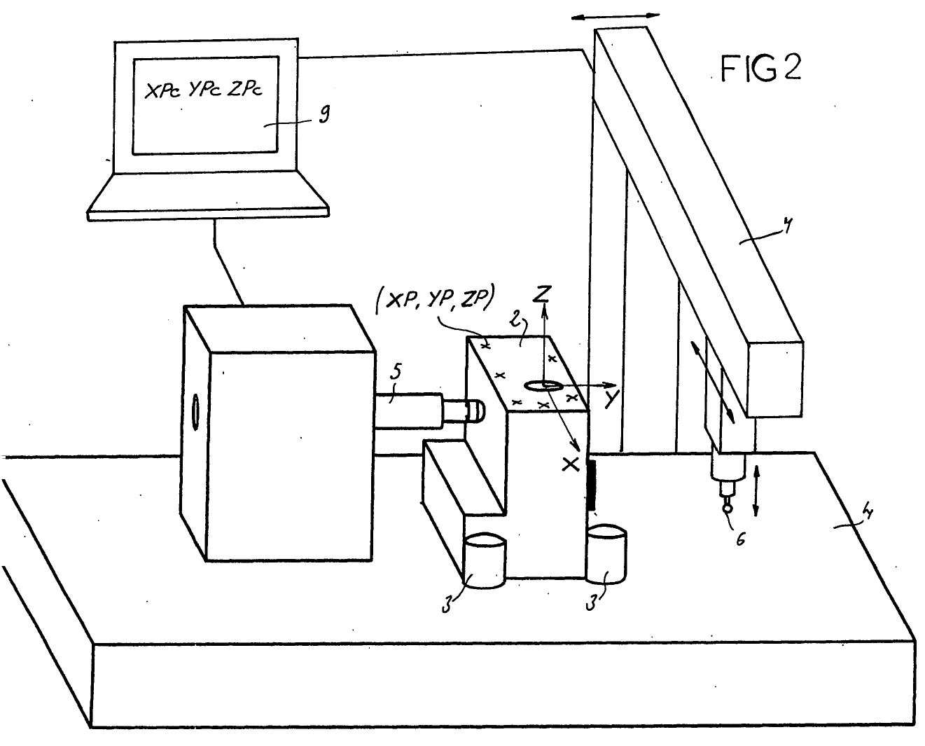

FIG. 2 represents a measurement of a part arising from an industrial process on a measurement rig under industrial conditions,

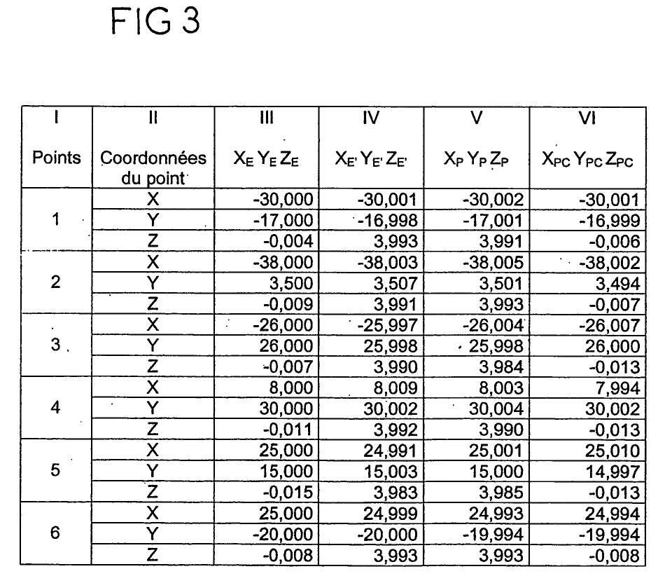

FIG. 3 shows an array of values of the coordinates of six points probed on a plane.

The function of the operation of measuring a mechanical part, that is to say a three-dimensional solid, is the verification of the conformity of the latter vis à vis a drawing exhibiting dimensions and tolerances.

The first step of the method according to the invention, which is not represented on the drawing, consists in making a gauge part 2 representative of the part to be made.

This gauge part 2 is generally made of steel and undergoes thermal processing so as to imbue it with high dimensional stability.

According to the function that the part is to fulfill, several significant points are chosen as having to be measured to determine geometric defects of the part (dimension, flatness, concentricity, etc.) which are critical for the functioning of this part.

In the example of a part represented on the drawing, the part deliberately exhibits a simple L shape and on this part it will be supposed that what one wishes to measure is the thickness of the vertical branch, referring to the part as it is oriented on the drawing and the flatness of one of the upper faces of the part.

The gauge part 2 representative of the part is measured in the laboratory. This measurement is made, in a conventional manner, with the aid of a coordinate measuring machine under controlled conditions, especially in terms of temperature. In the example, the thickness is measured at a point and the flatness at six points. For each of these points, i.e. seven in the example represented, one therefore has coordinates X_{E} Y_{E} Z_{E} which are tagged in a reference frame tied to the part. The values of the six points probed on the upper face of the gauge part 2 are stashed in column III of the array of FIG. 3.

The next step is done on a measurement rig which possesses means for positioning the part.

In the example represented, three fingers 3 disposed on a table 4 are involved.

These three fingers 3 enable the part to be received and define, with the plane of the table 4, a reference frame referred to as the part reference frame. This part reference frame is represented on the drawing.

It is noted that the measurement rig consists, on the one hand, of a unidirectional sensor 5, oriented along a horizontal general direction and of a prober 6 oriented along a vertical general direction and placed on the coordinate measuring machine 7.

The particular feature of the unidirectional sensor (in this instance an inductive sensor in the example represented) is that it is placed in the part reference frame according to precise coordinates. In the example represented, the probing point exhibits the following coordinates X=−10.000 and Z=−45.000, the coordinate along the Y axis being the coordinate that the sensor 5 is to measure.

On the rig thus defined, the gauge part 2 is placed on the plane 4 against the fingers 3 in the part reference frame.

The unidirectional sensor 5 and the prober 6 of the coordinate measuring machine make their measurement.

The unidirectional sensor 5 therefore measures the coordinate Y_{E} giving the thickness of the gauge part 2 measured by the machine in the part reference frame and, simultaneously, the prober 6 of the machine makes the measurements along the three axes X, Y, Z of the six points chosen to define the flatness of the upper face of the part. The coordinates X_{E′} Y_{E′} Z_{E′} are stashed in column IV of the array of FIG. 3.

Knowing for the gauge part 2 the coordinates X_{E} Y_{E} Z_{E} measured in the laboratory and the coordinates X_{E′} Y_{E′} Z_{E′} measured on the machine, it is easy to determine for each point, the deviation Δ between the coordinates X_{E} Y_{E} Z_{E} and the coordinates X_{E′} Y_{E′} Z_{E′} which correspond to the measurement error due to the rig and to do so under conditions (in particular of temperature) of an industrial environment.

The deviation Δ is stored in a memory of a calculation unit 9 that can be a microcomputer. The error related to the measurement rig being known, the gauge part 2 is removed from the measurement rig.

A part 10 arising from a production process is then placed in the part reference frame defined in the rig.

The seven significant points are measured by the unidirectional sensor and the prober of the coordinate measuring machine.

A series of coordinates X_{P} Y_{P} Z_{P} are thus obtained, in particular for the six points probed on the upper face of the part to be measured, whose coordinates are stashed in column V of the array of FIG. 3.

These coordinates X_{P} Y_{P} Z_{P} are processed in the computer according to a processing aimed at algebraically deducing the deviation Δ.

One thus obtains corrected coordinates X_{PC} Y_{PC} Z_{PC} which can be processed according to an appropriate digital processing such as the least squares procedure.

In the example represented, one thus determines:

| | |
|---|---|
| standard deviation | 0.00013 |
| flatness | 0.003 |
| Z = | −0.009 |

The method according to the invention therefore makes it possible to make measurements of coordinates of points relative to a gauge part, thereby rendering the method suitable for an industrial environment.

Of course, the invention is not limited to the embodiment described hereinabove by way of nonlimiting example, but on the contrary it encompasses all embodiments.

Thus, it is possible to envisage implementing it with only a plurality of unidirectional sensors whose respective positions are tagged in the part reference frame. It is also possible to envisage using only a coordinate measuring machine as measurement rig.

It should be noted that a downgraded coordinate measuring machine may be used within the context of the method according to the invention, since it is not then used to make a measurement obtained directly with respect to its measurement rules, but corrected with respect to a gauge representative of the part.

Additionally, the measurement rigs may be manually, semiautomatically or automatically controlled as regards the positioning of the part and of the gauge in the reference frame defined in the measurement rig but also as regards the mode of management of unidirectional sensors as well as the displacement of the three-dimensional sensors.

Likewise, the acquisition of the coordinates of points by the measurement rigs may be done in static mode, that is to say point by point, or in dynamic mode, that is to say by scanning.

A point which it is also important to note is that, to facilitate the usage of the significant points and, in particular, to correct them as a function of the temperature, the coordinates of these points are expressed in a part reference frame in the example described. Any other reference frame may be envisaged, such as the machine reference frame.

1. A method of three-dimensional measurement of coordinates of significant points of a part, comprising:
making a physical gauge representative of the part to be measured,
making a measurement in a meteorology laboratory of the coordinates X_{E} Y_{E} Z_{E} of significant points in a reference frame tied to the gauge,
making, in an industrial environment, a measurement of the coordinates of the significant points with a measurement rig that can give the three coordinates X_{E′} Y_{E′} Z_{E′} of each significant point in a reference frame tied to the gauge,
determining the deviation Δ for each significant point between the coordinates measured X_{E} Y_{E} Z_{E} under meteorology laboratory conditions and the coordinates measured X_{E′} Y_{E′} Z_{E′} under the industrial conditions of use,
storing in a memory the deviation Δ for each significant point,
making, on the part to be measured, in an industrial environment a measurement of the coordinates X_{P} Y_{P} Z_{P} of each significant point of a part with the measurement rig,
storing in a memory the coordinates X_{P} Y_{P} Z_{P},
performing a digital processing by a computer for correcting each coordinate X_{P} Y_{P} Z_{P} by algebraic deduction of the deviation Δ so as to obtain corrected coordinates X_{PC} Y_{PC} Z_{PC},
performing a digital processing of the corrected coordinates X_{PC} Y_{PC} Z_{PC} so as to determine a dimensional defect of the part.

2. The method of measurement as claimed in claim 1, further comprising processing the corrected coordinates X_{PC} Y_{PC} Z_{PC} by a mathematical procedure applied to the three-dimensional measurement.

3. The method of measurement as claimed in claim 2, further comprising processing the corrected coordinates X_{PC} Y_{PC} Z_{PC} by the least squares procedure.

4. The method of measurement as claimed in claim 1, further comprising:
fixing a unidirectional rig for measurement with respect to the part reference frame, two of the coordinates of the measurement rig being fixed in the reference frame tied to the part,
performing a measurement of a point of the part, two of the coordinates being the coordinates of the means of measurement in the reference frame, the third coordinate being the value sought.

5. A device allowing the implementation of The method of three-dimensional measurement of coordinates of significant points of a part as claimed in claim 1, the device comprising:
a physical gauge representative of the part to be measured,
a rig for measuring the part (10) to be measured that can be gauged by comparative measurement on the gauge,
a calculation unit connected to the measurement rig exhibiting storage means in which may be stored
the coordinates X_{E} Y_{E} Z_{E},
the coordinates X_{E′} Y_{E′} Z_{E′},
the deviation Δ for each significant point,
the coordinates X_{P} Y_{P} Z_{P}
and means of calculating the corrected coordinates X_{PC} Y_{PC} Z_{PC} by algebraic deduction of the deviation Δof the X_{P} Y_{P} Z_{P} and of processing of the corrected coordinates X_{PC} Y_{PC} Z_{PC} by a procedure applied to the three-dimensional measurement.

6. The device as claimed in claim 5, further comprising a measurement rig operating by probing, by optical, pneumatic or capacitive measurement.

7. The device as claimed in claim 6, wherein the measurement rig is a three-dimensional measurement rig capable of determining three coordinates of a point of the part in a reference frame tied to the part.

8. The device as claimed in claim 7, wherein the measurement rig is a coordinate measuring machine.

9. The device as claimed in claim 8, wherein the measurement rig comprises unidirectional elements of the measurements and three-dimensional elements of measurements.
